(19) United States
(12) Patent Application Publication
(10) Pub. No.: US 2014/0143065 A1
(43) Pub. Date: May 22, 2014

(54) VIRTUAL WAREHOUSE AND METHOD OF USE FOR THE POSTING AND SALE OF GOODS, NAMELY, CONTAINER SUCH AS DRUMS OR BARRELS OF HAZARDOUS MATERIALS

(71) Applicant: Patrick Mc Dermott, Coarl Springs, FL (US)

(72) Inventor: Patrick Mc Dermott, Coarl Springs, FL (US)

(21) Appl. No.: 13/683,008

(22) Filed: Nov. 21, 2012

(51) Int. Cl. G06Q 30/06

(52) U.S. Cl. CPC G06Q 30/0607
USPC 705/14.69; 705/27.2; 705/26.25

(57) ABSTRACT

A computer program accessible on a website displays a virtual warehouse containing representations of a number of virtual items corresponding to specific physical item counterparts owned by and to individuals having identities stored by the program. The physical items optionally are drums containing chemicals. A method for executing a sale of an item on the website includes the steps of providing a website which displays a virtual location containing representations of a number of virtual items corresponding to specific physical item counterparts; two potential users becoming registered program users as one of a buyer user and a seller use; the seller user moving the virtual item from a first virtual location displayed on the website to a second virtual location displayed on the website, and thereby putting the item up for sale; and the buyer user searching the website for virtual images of desired items.

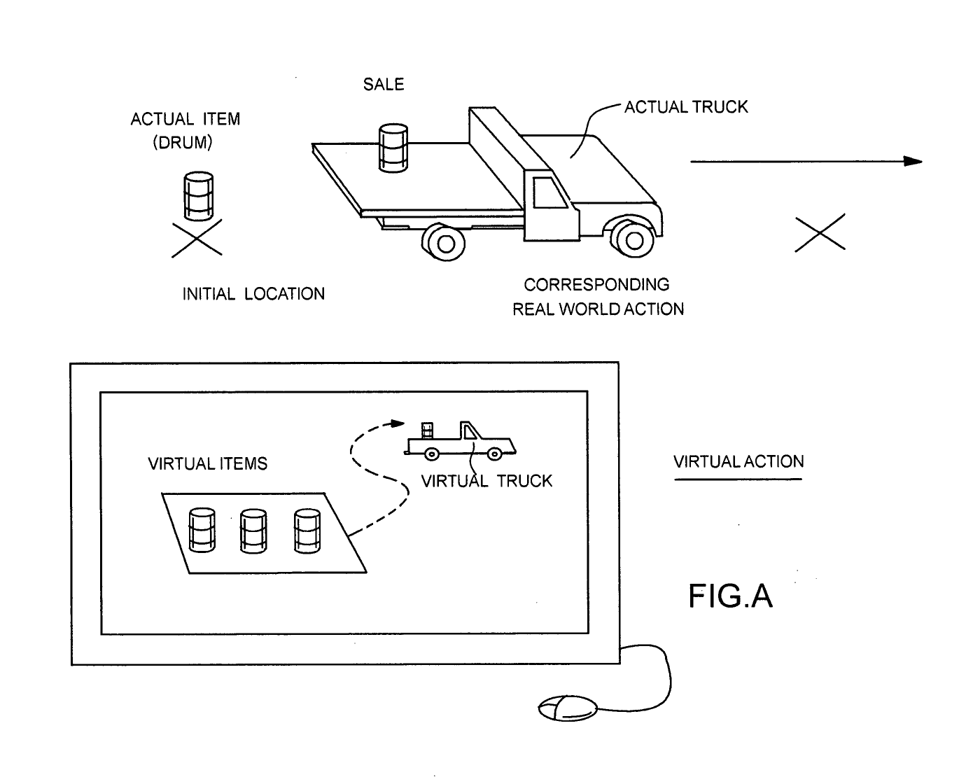

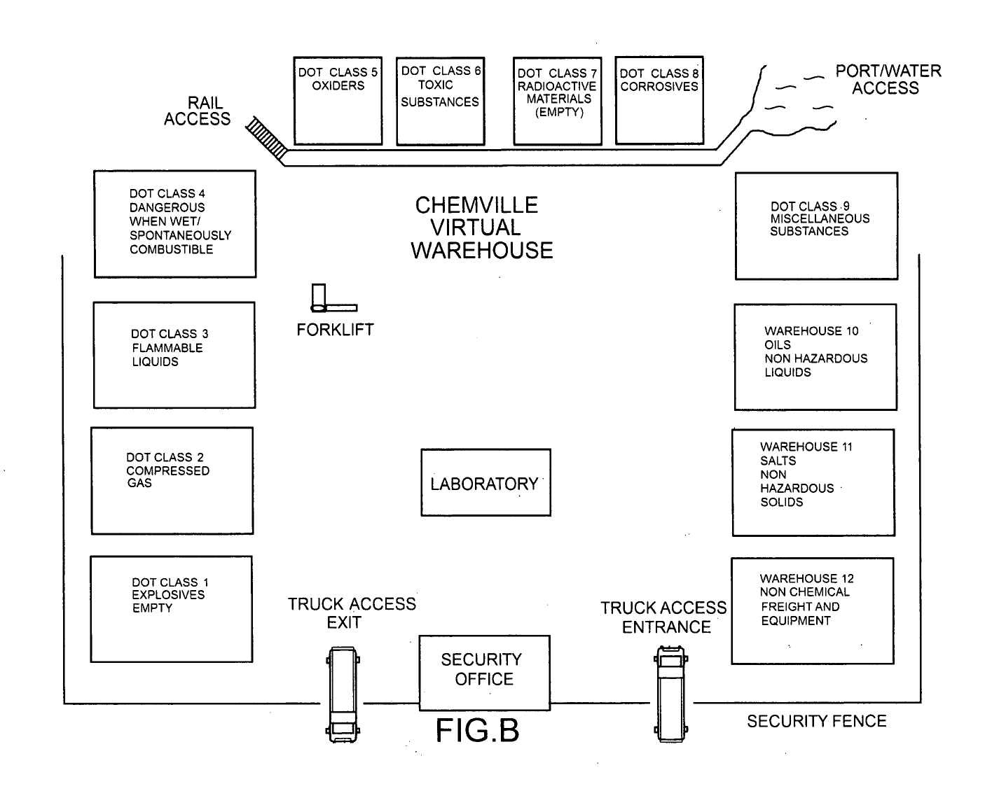

### FILING HISTORY

This application continues from provisional patent application No. 61/629,535 filed on Nov. 21 2011.

### BACKGROUND OF THE INVENTION

1. Field of the Invention

The present invention relates generally to the fields of sales of unused chemicals. More specifically the present invention relates to a computer program accessible on a website which displays a virtual warehouse containing representations of a number of virtual items corresponding to specific physical item counterparts such as drums, totes, pails, IBC's, bottles, carboys, bags, sacks, vessels and cylinders of unused chemicals owned by and for sale to individuals having identities stored by the program, the physical item counterparts being located on any continent in the world, whether at a single facility or scattered individually or in groups throughout numerous geographical locations and storage facilities, and to the method steps executed by the program and its users. The virtual imagery created by the program and manipulated by the user preferably includes numerous warehouses within a storage facility with internal walls subdividing the warehouse space into regions designated for various types of items. For example, one warehouse might contain virtual drums of flammable chemicals, and various types of flammable chemicals may be sub-grouped within the given region. Other individual warehouses might be dedicated to and contain only paints, acids, caustic sodas, virgin chemicals, or water treatment containers. A warehouse might be devoted to a very specific single type of item, such as drums of acetone. A warehouse may also be designated for non-chemical freight. The website virtual imagery optionally includes a virtual or animated staff, i.e., a security guard at the gate leading to the warehouse, a lab technician, a fork lift operator, and so forth, and appropriate music to accompany usage and execution of specific program method steps.

The method includes the general steps of becoming a registered program user, whether as a buyer or as a seller or both. Users optionally remain anonymous on the site, their identities known only to the program owner. A program user, whether a buyer or seller, can be removed from the registered user list and thereby denied use of the website for breaking website rules or engaging in disreputable business practices.

The method steps for the seller user include logging onto the website, clicking on a virtual item matching the physical items to be sold, and moving the virtual item such as by dragging it with a mouse from a virtual box truck to the virtual warehouse, or to a virtual storage shed. In this way the item is put up for sale on the website. During these computer transactions, users interact with a visual, possibly animated.

The method steps for the buyer user include searching the website for specific desired items, of accessing information about the physical counterparts of any of the virtual items displayed, and specifically of those located in a website search, and of moving selected virtual items on the website display, such as by clicking on and dragging the virtual item with a mouse from the warehouse to another symbolic virtual location on the website display, such as a virtual truck, train, ship or loading dock, thereby sending a message to the program owner that a user is interested in buying an item posted by another user, and preferably automatically concluding a sales transaction between the two users for a given item or items. A further optional additional step includes generating a statement in including or adding a commission for the program owner as a percentage of the item sales price.

A second embodiment of the invention and program includes posting advertisements on the website for such items as described above, for an advertising fee paid to website owner, either in advance or at the moment a sales transaction is executed. There will be options regarding payment for advertising or purchasing, such as direct purchase, or purchase via credits from an existing account, or monetized credit.

2. Description of the Prior Art

There has long been a need to make use of unused, virgin, expired but still safe, surplus chemicals, particularly hazardous chemicals. In the cost of disposing of unused chemicals which can be called waste, in conformity with disposal requirements can be high. It is estimated that it costs up to $1000.00 or more to properly dispose of unused hazardous chemicals, not including drum transportation costs. And it is a business reality that disposal and recycling facilities can be difficult to work with and unreliable. Furthermore, chemical disposal is not only costly, but more often than not is simply wasteful of resources. Many of the chemicals sent for disposal by one company would be useful to another company, which has to go elsewhere to purchase them.

It is thus an object of the present invention to provide a computer program which operates an interactive website for bringing together individuals such as companies who have chemicals or other items such as those requiring disposal and individuals who wish to purchase those very unused chemicals or other items, and means to execute a purchase transaction for the items.

It is another object of the present invention to provide such a program which displays on a computer screen a virtual and/or animated warehouse containing virtual representations of items and/or technical data sheets listing such items for sale or specifically requiring disposal which correspond directly with actual physical items at locations anywhere in the world, and which optionally provides a picture of and an MSDS sheet for each displayed virtual item corresponding to an actual physical item.

It is still another object of the present invention to provide such a program which benefits the environment by minimizing quantities of used chemicals taken to disposal sites as well as substantially reducing the energy costs of disposal, and gaining energy credits for the energy put into the item when produced which has been saved through use rather than disposal.

It is yet another object of the present invention to provide such a program which includes various a payment mechanisms for users and which may calculate and deduct a commission for the program owner, or which may provide item advertising for an advertising fee or purchase of credits for advertising or item purchase.

It is a further object of the present invention to provide such a program which screens and registers program users as either buyers or sellers, or as both, and which either posts and sells items as is.

It is a still further object of the present invention to provide such a program which can aid the buyer and the seller in arranging for the transportation of each purchased item.

It is a yet further object of the present invention to provide such a program which provides the program user with a real world experience in a virtual setting. As an example, just as a shipper would deliver a physical drum to a warehouse, the program user has the same real world visual experience on line of delivering a drum to the warehouse and removing it.

It is finally an object of the present invention to provide such a program which is easy to use, fun, entertaining, personally engaging, and which conveys through virtual imagery a transaction in progress operated by a program user logged into the program website, such as with a mouse, joystick, keyboard, smart phone or tablet and which is optionally a game related program.

### SUMMARY OF THE INVENTION

The present invention accomplishes the above-stated objectives, as well as others, as may be determined by a fair reading and interpretation of the entire specification.

A computer program accessible on a website is provided, including a program for displaying a virtual warehouse containing representations of a number of virtual items corresponding to specific physical item counterparts owned by and to individuals having identities stored by the program. The physical items optionally of drums containing chemicals.

A method for executing a sale of an item on the world wide web is also provided, including the steps of: providing a website which displays a virtual location containing representations of a number of virtual items corresponding to specific physical item counterparts; two potential users becoming registered program users as one of a buyer user and a seller user and as both a buyer and seller user; a seller user logging onto the website; the seller user moving the virtual item from a first virtual location displayed on the website to a second virtual location displayed on the website, and thereby putting the item up for sale; and a buyer user logging onto the website; the buyer user searching the website for virtual images of desired items; the buyer user accessing information about the physical counterparts of any of the virtual items displayed on the website; and the buyer user moving selected virtual items on the website display from the second virtual location to a third virtual location; the program sending a message to the program owner in response to the virtual item movement by the buyer user that the buyer user is interested in buying an item posted by the seller user, and concluding a sales transaction between the seller user and the buyer use for a given item. The seller preferably moves a virtual item by clicking on and dragging the virtual item with a mouse.

### BRIEF DESCRIPTION OF THE DRAWINGS

Various other objects, advantages, and features of the invention will become apparent to hose skilled in the art from the following discussion taken in conjunction with the following drawings, in which:

FIG. A is a schematic of a central aspect of the present invention.

FIG. B is a floor plan of a preferred version of the virtual warehouse.

Various pages and documents are additionally incorporated by reference from the provisional application from which this application continues. These additional pages and documents form part of the disclosure of the present invention, and include two pages of “Chemville Virtual Warehouse High Level Process Flow” chart; two sheets of “Storage Growth Via Branch Concept” sketch sheet illustrating two different growth concepts; one sheet of “Chemville Basic Visual Site Diagram” one page from applicant website “Save an atom, recycle a molecule, Chemville the first chemical e-storage facility located in cyberspace”, and eleven pages of “Chemville Chemical Online Warehouse Software Requirements Specification”.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

Referring to the FIGURES, a computer program is disclosed which is accessible on a website which displays a virtual warehouse containing representations of a number of virtual items corresponding to specific physical item counterparts such as drums of chemicals owned by and to individuals having identities stored by the program, the physical item counterparts being located on any continent in the world, whether at a single facility or scattered individually or in groups throughout numerous geographical locations and storage facilities, and to the method steps executed by the program and its users. The virtual imagery created by the program and manipulated by the user preferably includes a warehouse with internal walls subdividing the warehouse space within a facility into regions designated for various types of items. For example, one region might contain virtual drums of flammable chemicals, and various types of flammable chemicals may be sub-grouped within the given region. Other individual regions might be dedicated to and contain only paints, acids, caustic sodas, virgin chemicals, or water treatment drums. A entire region might be devoted to a very specific single type of item, such as drums of acetone. The website virtual imagery optionally includes a virtual security guard at the gate leading to the warehouse, and appropriate music to accompany usage and execution of specific program method steps.

### Method

In practicing the invention, the following method may be used. The method includes the general steps of becoming a registered program user, whether as a buyer or as a seller or both. User preferably remain anonymous on the site, their identities known only to the program owner.

The method steps for the seller user include logging onto the website, clicking on a virtual item matching the physical items to be sold, and moving the virtual item such as by dragging it with a mouse from a virtual box truck to the virtual warehouse, or to a virtual storage shed. In this way the item is put up for sale on the website. The method preferably includes the additional step of assigning each item an item identification number for more efficient locating, storing and tracking.

The method steps for the buyer user include searching the website for specific desired items, of accessing information about the physical counterparts of any of the virtual items displayed, and specifically of those located in a website search, and of moving selected virtual items on the website display, such as by clicking on and dragging the virtual item with a mouse from the warehouse to another symbolic virtual location on the website display, such as a virtual truck or loading dock, thereby sending a message to the program owner that a user is interested in buying an item posted by another user, and preferably automatically concluding a sales transaction between the two users for a given item or items. The method steps preferably also include displaying a picture in the form of an actual photograph of and an MSDS sheet for each displayed virtual item corresponding to an actual physical item, such as by the user double clicking on a given virtual item such as a particular drum. The method the steps preferably yet further include the program displaying a liability limiting contract for the user to scroll through and accept or decline by operating a mouse or a keyboard such as to indicate agreement to its terms, and the steps preferably further include displaying disclaimers of liability for damage or mis-routing during item transport, and of item characteristics.

### Second Preferred Embodiment

A second embodiment of the invention and program includes posting advertisements on the website for such items as described above, for an advertising fee paid to website owner, either in advance or at the moment a sales transaction is executed. The program preferably displays and permits manipulation of virtual items to represent the posting, searching, and purchasing in the same virtual form with substantially the same method steps as for the first embodiment, the only essential difference being that the website owner receives payment through a direct, flat advertising fee rather than through a percentage commission calculated and deducted during item sale transactions.

Finally, fiat unsalable items, an actual outright disposal service is optionally provided through the website.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. A computer program accessible on a website, comprising:
program means for displaying a virtual warehouse containing representations of a number of virtual items corresponding to specific physical item counterparts owned by and to individuals having identities stored by the program.

2. The computer program of claim 1, wherein said physical items are drums containing chemicals.

3. A method for executing a sale of an item on the world wide web, comprising the steps of:
providing a website which displays a virtual location containing representations of a number of virtual items corresponding to specific physical item counterparts;
two potential users becoming registered program users as one of a buyer user and a seller user and as both a buyer and seller user;
a seller user logging onto the website;
the seller user moving the virtual item from a first virtual location displayed on the website to a second virtual location displayed on the website, and thereby putting the item up for sale;
and a buyer user logging onto the website;
the buyer user searching the website for virtual images of desired items;
the buyer user accessing information about the physical counterparts of any of the virtual items displayed on the website;
and the buyer user moving selected virtual items on the website display from the second virtual location to a third virtual location;
the program sending a message to the program owner in response to the virtual item movement by the buyer user that the buyer user is interested in buying an item posted by the seller user, and concluding a sales transaction between the seller user and the buyer user for a given item.

4. The method of claim 3, wherein the user seller moves a virtual item matching a physical item the seller user wishes to sell by clicking on and dragging the virtual item with a mouse.

5. The method of claim 3, comprising the additional step of the program withholding identifying information about program users from display on the website.

6. The method of claim 3, wherein the virtual item is initially displayed on a virtual truck and is moved by the seller user to one of a virtual warehouse and a virtual storage shed to place the item for sale.

7. The method of claim 3, wherein the buyer user moves a selected virtual item by dragging the virtual item across the screen by clicking on the virtual item and dragging it by operation of a mouse.

8. The method of claim 3, wherein the sale s transfer is executed by the program automatically.

9. The method of claim 3, wherein the first virtual location is a virtual truck, and the second virtual location is a virtual warehouse, and the third virtual location is one of another virtual truck and a loading dock.

10. The method of claim 3, comprising the additional step of assigning each item an item identification number for more efficient locating, storing and tracking.

11. The method of claim 3, comprising the additional step of generating a statement with a commission for delivery to the program owner as a percentage of the sales price of an item sold through the website.

12. The method of claim 3, comprising the additional step of displaying a picture of the physical item corresponding to a displayed virtual item.

13. The method of claim 3, comprising the additional step of displaying an MSDS sheet for the physical item corresponding to a displayed virtual item.

14. The method of claim 12, comprising the additional step of a user displaying a picture of the physical item corresponding to a displayed virtual item by double clicking on a given virtual item such as a particular drum.

15. The method of claim 3, comprising the additional step of the program displaying a liability limiting contract for the user to scroll through and one of accept and decline.

16. The method of claim 3, comprising the additional step of displaying disclaimers of liability for at least one of damage during item transport to the buyer user and mis-routing during item transport to the buyer user, and actual physical item characteristics.

17. The method of claim 3, wherein the virtual imagery created by the program and manipulated by the user comprises a virtual warehouse with internal walls subdividing the virtual warehouse space into regions designated for containing various types of virtual items.

18. The method of claim 3, comprising the additional step of posting advertisements on the website for such items as described above, for an advertising fee paid to website owner one of in advance and at the moment a sales transaction is executed.

19. The method of claim 4, wherein the virtual item is a drum containing a chemical.

20. The method of claim 3, comprising the additional step of disposing of an unsalable physical item in exchange for a fee from the seller user.
